(19) United States
(12) Patent Application Publication
(10) Pub. No.: US 2017/0037968 A1
(43) Pub. Date: Feb. 9, 2017

(54) Piston-Connecting Rod Assembly

(71) Applicant: Caterpillar Inc., Peoria, IL (US)

(72) Inventors: Austin P. Roe, Morton, IL (US); Daniel Vogel, Mapleton, IL (US); Bradley Morgan, Peoria, IL (US); Shu Zhang, Dunlap, IL (US)

(73) Assignee: Caterpillar Inc., Peoria, IL (US)

(21) Appl. No.: 14/820,252

(22) Filed: Aug. 6, 2015

(51) Int. Cl. F16J 1/16; F16C 7/02

(52) U.S. Cl. CPC F16J 1/16; F16C 7/023

(57) ABSTRACT

A piston-connecting rod assembly for an internal combustion engine includes a piston pivotally mated to a connecting rod by a piston pin. The piston pin includes a first pin end, a second pin end, and a midsection. When assembled, the first pin end and second pin end are respectively received in a first pin bore and second pin on the piston while the midsection is accommodated in a cross-bore through the connecting rod. The piston pin may include a wear resistant layer applied over at least a portion of its external surface that may include at least one of tungsten disulfide and molybdenum disulfide. The wear resistant layer may be applied as part of a manufacturing process performed on the piston pin.

### TECHNICAL FIELD

This patent disclosure relates generally to a piston and connecting rod assembly and, more particularly, to the piston pin used to pivotally connect the piston with the connecting rod.

### BACKGROUND

Internal combustion engines are widely used to combust a fuel, often a hydrocarbon-based fuel such as diesel or gasoline, and convert the chemical energy therein to mechanical power that can be harnessed for work. To conduct the combustion process and convert the released energy into a force or motion, the internal combustion engine typically includes a combustion chamber, such as a cylinder, inside of which is a reciprocally disposed a piston. The piston is connected to one end of a connecting rod that is also connected at its other end to a crankshaft. When fuel is introduced and combusted in the combustion chamber, the expanding gasses forcibly move the piston downward within the cylinder, the linear motion of which is converted to rotational motion by the crankshaft. The fuel may be ignited by a spark ignition or due to compression as the piston again moves upwards within the combustion chamber.

To connect the piston to the connecting rod, often a cylindrical-shaped piston pin, sometimes referred to as a gudgeon pin or wrist pin, is included as part of the piston and connecting rod assembly. The midsection of the piston pin may be partly received in a cross-bore disposed through the piston end of the connecting rod while the opposing ends of the piston pin can be received in respective pin bores disposed and aligned with each other in the underside of the piston through the piston skirt. The piston pin and the cross-bore and pin bores can be sized so that the pin floats within the bores. This construction enables the connecting rod to pivot with respect to the underside of the piston in a manner that enables the linear motion of the piston to cause rotation of the crankshaft.

It can be appreciated that the piston pin may be subjected to a significant degree of stress and friction when the piston is forcibly moved during a combustion event and the connecting rod pivots with respect to the piston. Accordingly, the piston and connecting rod assembly may be designed with special features to accommodate such forces. One example of such a design may be found in U.S. Pat. No. 6,923,153, which describes a piston and connecting rod assembly where the piston has a reduced diameter at its midsection compared to the diameter of the pin at its ends. In addition, the connecting rod may include a phosphatized coating at the pin end to facilitate movement between the connecting rod and the piston pin. The present disclosure is likewise directed to a piston and connecting rod assembly designed to accommodate the stresses and motions generated by the application.

### SUMMARY

The disclosure describes, in one aspect, a piston-connecting rod assembly for an internal combustion engine. The piston of the assembly includes a crown and a skirt depending from the crown that has a first pin bore and an aligned second pin bore disposed into it. The connecting rod includes a piston end having a cross-bore and a crank end adapted to connect to a crankshaft. The pin end and the crank end are interconnected by a beam. To pivotally mate the piston to the connecting rod, a piston pin can be received through the first and second pin bores and the cross-bore. The piston pin can include a wear resistant layer including at least one of tungsten disulfide and molybdenum disulfide applied on at least a portion of an exterior surface of the piston pin.

In another aspect, the disclosure describes a method for constructing a piston-connecting rod assembly which includes a piston and a connecting rod pivotally connected together. According to the method, a piston pin is formed which includes a first pin end, a second pin end, and a midsection disposed between the first pin end and the second pin end. The method involves applying a wear resistant layer to at least a portion of the piston pin which includes at least one of tungsten disulfide and molybdenum disulfide. To assemble the piston and the connecting rod, the cross-bore of the connecting rod is aligned with a first pin bore and a second pin bore disposed in the piston. Further according to the method, the piston pin is then inserted into the first pin bore, the cross-bore, and the second pin bore to pivotally connect the piston and the connecting rod.

In yet another aspect, there is described a piston pin for pivotally connecting a piston and a connecting rod together. The piston pin includes a body that is generally cylindrical in shape and made of iron or steel and that has a first end, a second end, and a midsection disposed between the first end and the second end. The piston pin further includes a wear resistant layer containing at least one of tungsten disulfide and molybdenum disulfide. The wear resistant layer may be applied to at least the first pin end and the second pin end.

### BRIEF DESCRIPTION OF THE DRAWINGS

FIG. 1 is a cross-sectional view illustrating an embodiment of an internal combustion engine including a piston reciprocally disposed in a cylinder and connected to a connecting rod by a piston pin.

FIG. 2 is a perspective view of the piston pin having a wear resistant coating in accordance with the present disclosure that is disposed on at least a portion of its exterior surface.

FIG. 3 is a cross-sectional view of the piston and the connecting rod as pivotally joined by the piston pin of FIG. 2.

FIG. 4 is a schematic diagram, on a microscopic scale, of a mechanical manufacturing process for applying the wear resistant coating to the piston pin.

### DETAILED DESCRIPTION

This disclosure relates to an internal combustion engine and, in particular, to the design of the piston-connecting rod assembly included with the internal combustion engine. The internal combustion engine may be utilized to power a working machine such as those that perform some type of operation associated with an industry such as mining, construction, farming, transportation, or any other industry known in the art. For example, the machine may be an earth-moving machine, such as a wheel loader, excavator, dump truck, backhoe, motor grader, material handler or the like. Moreover, an implement may be connected to the machine. Such implements may be utilized for a variety of tasks, including, for example, loading, compacting, lifting, brushing, and include, for example, buckets, compactors, forked lifting devices, brushes, grapples, cutters, shears, blades, breakers/hammers, augers, and others. However, in other embodiments, the machine may be a stationary machine, such as an electrical generator or a large pump that is operatively coupled to the internal combustion engine to receive the power output of the engine.

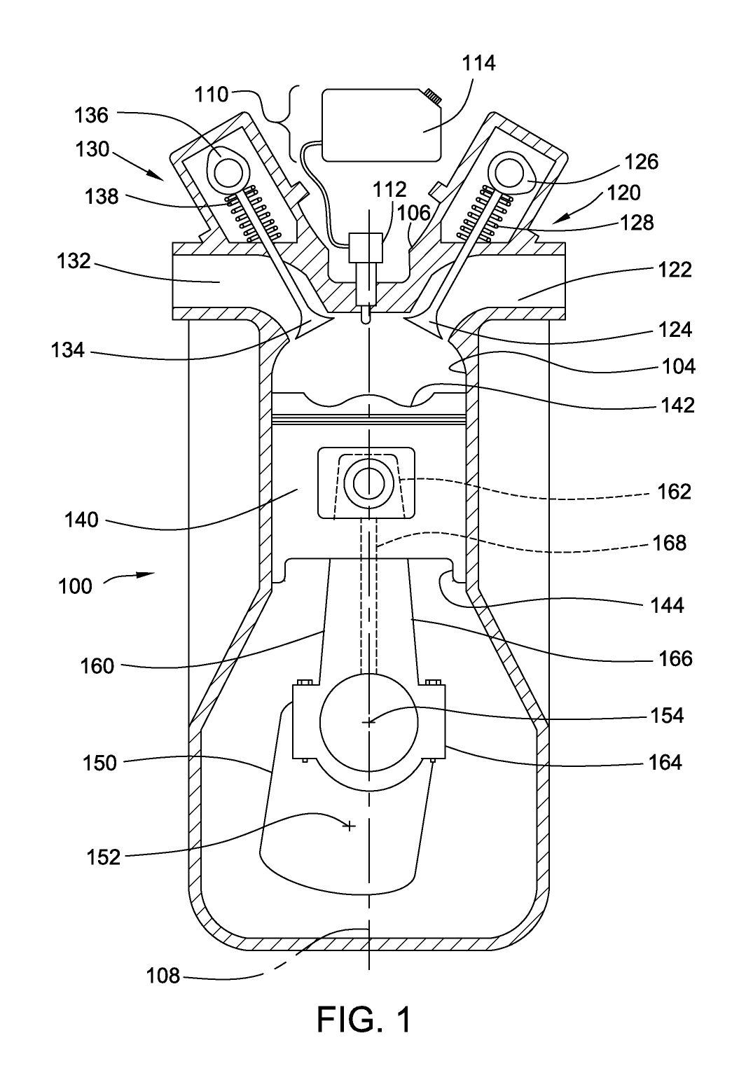

Now referring to the drawings, wherein like reference numbers refer to like elements, there is illustrated in FIG. 1 a cross-section of a representative embodiment of an internal combustion engine 100 for producing mechanical power from the combustion of fuel. In particular, FIG. 1 illustrates a single combustion chamber 102 of the internal combustion engine 100 with the associated components and features, however, in various embodiments, the internal combustion engine may include any suitable number of combustion chambers such as commonly employed in four-chamber, eight-chamber, and sixteen-chamber designs. Moreover, the combustion chambers 102 may be arranged in any suitable manner such as an in-line design as indicated in FIG. 1, a V-configuration design, or possibly a radial design. The combustion chamber 102 itself is a cylindrical, enclosed space delineated by a cylinder wall 104 and a cylinder head 106 that encloses the chamber. The cylindrical shape of the combustion chamber 102 further delineates a cylinder axis 108. The internal combustion engine 100 may be of a compression ignition design in which a mixture of fuel, such as diesel, and air is compressed in the combustion chamber 102 thereby raising the pressure and temperature of the mixture to the point of spontaneous auto-ignition. However, in other embodiments, the internal combustion engine may be of a spark-ignition design in which the mixture of fuel and air is ignited by a sparkplug or the like.

To introduce fuel to the combustion chamber 102, the internal combustion engine 100 may be operatively associated with a fuel system 110 that can include one or more fuel injectors 112 disposed in the cylinder head 106. The fuel injector 112 can be in fluid communication with a refillable fuel reservoir 114 in which the combustible fuel is stored. The fuel system 110 may include other components to facilitate the delivery of pressurized fuel to the fuel injector 112 such as pumps, filters, runners, and the like. To introduce intake air for the combustion process, the internal combustion engine 100 includes an intake air system 120 having various channels, manifolds or intake ports 122 disposed through the cylinder head 106 for directing air to the combustion chamber 102. The intake air can be selectively introduced to the combustion chamber 102 by operation of an intake valve 124 that seals the intake ports 122 from the chamber and that can be opened by operation of an associated cam 126. Further, the intake valve 124 returns to the closed position by the urging of a valve spring 128. To exhaust the combustion products from the combustion chamber 102 after ignition, the internal combustion engine 100 may be operatively associated with an exhaust system 130 that, like the intake air system 120, includes various channels and exhaust ports 132 disposed in the cylinder head 106 leading from the combustion chamber. To selectively establish fluid communication between the combustion chamber 102 and the exhaust ports 132, the exhaust system 130 also includes an exhaust valve 134 that opens and closes by operation of an associated cam 136 and valve spring 138. Although only one intake valve 124 and one exhaust valve are shown in FIG. 1, it should be appreciated that, in various embodiments of the internal combustion engine 100, multiple valves can be included. The internal combustion engine may be operatively associated with any other suitable devices or systems such as, for example, a turbocharger and an exhaust gas recirculation (EGR) system.

When fuel and air introduced to the combustion chamber 102 are ignited, the resulting combustion and expansion of gasses forcibly moves a piston 140 reciprocally disposed in the combustion chamber 102 downwards with respect to the cylinder axis 108. The piston 140 may include a piston crown 142 generally arranged perpendicularly to the cylinder axis 108 and a piston skirt 144 that has a diameter corresponding to and making sliding contact with the cylinder wall 104. In particular, the piston 140 can move linearly from a top dead center (TDC) position in which the piston is closest to the cylinder head 106 to a bottom dead center (BDC) position where it is farthest from the cylinder head. To convert the linear motion of the piston 140 to the rotational motion output from the internal combustion engine 100, the piston can be connected to a crankshaft 150 rotationally disposed below the combustion chamber 102 along a crank axis 152 that is normal to the cylinder axis 108. The crankshaft 150 includes one or more crank throws 154 that are eccentrically arranged with respect to and offset from the crank axis 152. Accordingly, the crank throws 154 revolve around the crank axis 152 accommodating the downward movement of the piston 140. Similarly, the offset between the crank axis 152 and the crank throws 154 enable the crankshaft 150 to force the piston back upwards to the TDC position as the crankshaft rotates through a 360° revolution, for example, to enable the piston to conduct an exhaust stroke exhausting combustion products from the combustion chamber 102 or a compression stroke compressing the fuel-air mixture. To withstand the temperatures and stresses of the intended application, the piston and the crankshaft can be made from machined steel or iron or another iron based material. In further embodiments, the piston can also be made from aluminum or an aluminum alloy.

To connect the piston 140 to the crankshaft 150, the internal combustion engine 100 can include a connecting rod 160 operatively associated with the two elements. The connecting rod 160 can be an elongated structure extending between a piston end 162, sometimes referred to as the small end, and a crank end 164, sometimes referred to as the big end, that are spaced apart by a beam 166. When assembled together, the piston end 162 connects with the piston and the crank end 164 can couple about one of the crank throws 154 of the crankshaft 150. Due to the eccentrically offset arrangement of the crank throws 154, the reciprocal vertical motion of the piston end 162 in conjunction with the piston 140 will result in an oscillating motion of the crank end 164 with respect to the crank axis 152. Further, this motion will cause the beam 166 of the connecting rod 160 to pivot with respect to the underside of the piston 140 and in a side-to-side manner across the cylinder axis 108. In an embodiment, to channel oil to and about the piston 140, the connecting rod 160 may include a lubrication channel 168 disposed through the beam 166 that can receive pressurized oil from complementary channels in the crankshaft and direct the oil upwards due to inertia caused the reciprocal movement of the connecting rod. The connecting rod 160 can be made from cast or machined steel or iron or another iron based material.

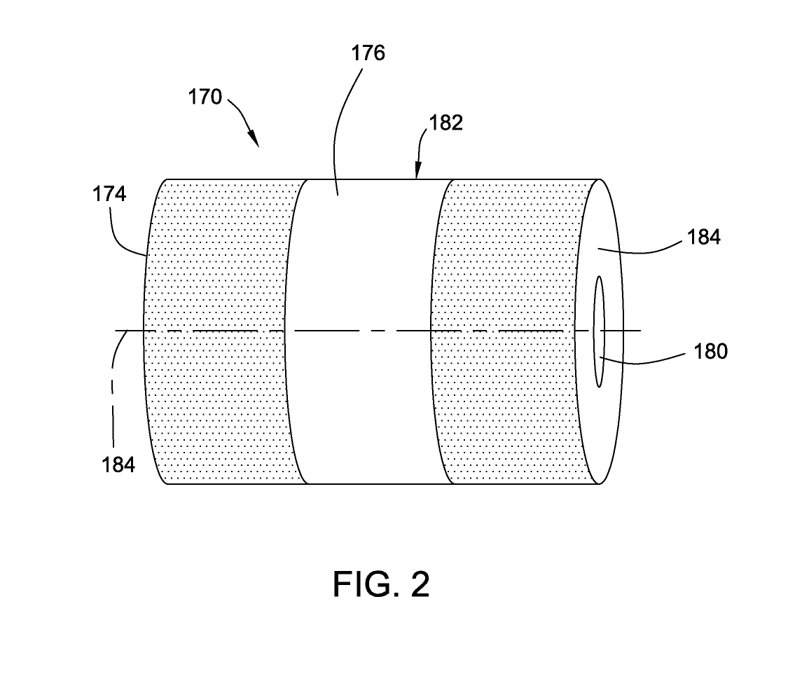

To enable the connecting rod 160 to pivot with respect to the piston 140, a piston pin 170 can be used to mate the piston end 162 of the connecting rod to the piston underneath the piston skirt 144. Referring to FIG. 2, the piston pin 170 can have a short, generally cylindrical, rod-like body with a first pin end 172 and an opposite second pin end 174 spaced apart by a midsection 176. Further, the piston pin 170 can be tubular and therefore includes an interior bore 180 surrounded by an exterior surface 182 that corresponds to the general, cylindrical shape. Hence, the piston pin 170 can define a pin axis 184 about which the interior bore 180 and exterior surface 182 are concentrically aligned. The piston pin can be made from any suitable material including, for example, steel or iron.

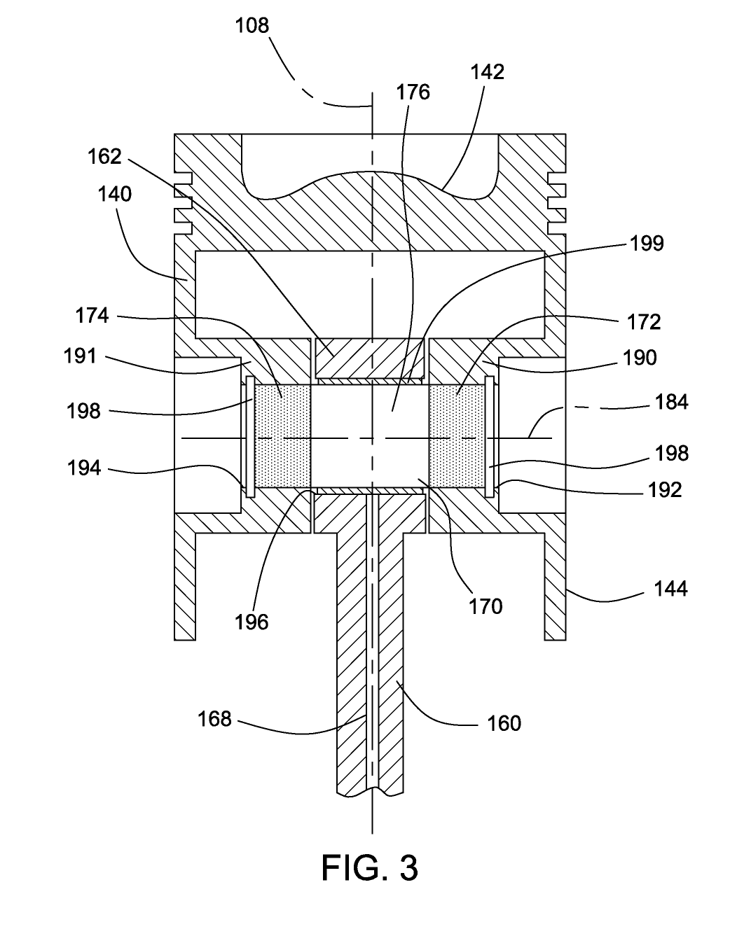

Referring to FIG. 3, to mate the piston 140, the connecting rod 160, and the piston pin 170 together, the pin is accommodated in correspondingly shaped bores disposed through the piston and connecting rod. In particular, the piston 140 can include a first pin boss 190 and second pin boss 191 that are disposed radially inward into the piston skirt 144. Further, disposed into the first and second pin bosses 190, 191 can be a first pin bore 192 and a second pin bore 194, respectively, that may be circular in shape and that align with respect to each other across the piston skirt 144. The piston end 162 of the connecting rod 160 can also have a cross-bore 196 disposed through it such that the pin end can be inserted into the piston skirt 144 and positioned between the first pin boss 190 and second pin boss 191 and the cross-bore can be aligned with the first and second pin bores 192, 194. The piston 140 and connecting rod 160 can thereafter be mated together by inserting the piston pin 170 through the aligned first and second pin bores 192, 194 and the cross-bore 196. The piston pin 170 is therefore arranged with the pin axis 184 generally perpendicular to the cylinder axis 108 that the piston 140 reciprocally moves up and down along. To prevent the piston pin 170 from working its way out of the first pin bore 192, second pin bore 194, and/or cross-bore 196, C-clips or snap rings 198 can be installed in corresponding grooves disposed in the first and second pin bores 192, 194 to capture the piston inside the bores.

When the piston pin 170 is received in the piston 140 and connecting rod 160 in the foregoing manner, the first pin end 172 is disposed in direct sliding contact with the first pin bore 192 of the first pin boss 190 and the second pin end 174 is disposed in direct sliding contact with the second pin bore 194 of the second pin boss 191. The midsection 176 further aligns with the cross-bore 196 of the piston end 162 of the connecting rod 160. In a possible embodiment, to support the piston pin 170, the piston end 162 of the connecting rod 160 may include an additional bushing 199, made of copper or bronze, that is installed in the cross-bore 196 by press-fitting or the like and that surrounds the piston pin. To lubricate the interface between the bushing 199 and the piston pin 170, the bushing may receive oil from the lubrication channel 168 disposed in the connecting rod 160. The complementary shapes between the generally cylindrical piston pin 170 and the circular first pin bore 192, second pin bore 194, and cross-bore 196 or bushing 199 installed therein enables the parts to slidably rotate with respect to each other so that the piston 140 and connecting rod 160 are pivotally connected and pivot with respect to the pin axis 184. In an embodiment, the piston pin 170 may be floating with respect to both the first and second pin bores 192, 194, cross-bore 196, and/or the bushing 199 while in other embodiments, it may be fixed with respect to one of the bore sets and/or bushing.

The relative motion between the piston pin and the bores can result in significant frictional wear between the surfaces and possible seizure between the parts. Further, in the intended application, the reciprocal, up and down motion of the piston 140 will apply significant shearing forces to the piston pin 170 that can compound the effect of the kinetic friction between the parts. To reduce the negative effects of friction and/or wear, the piston pin 170 can be provided with a solid, wear resistant layer 200 having low friction properties disposed or applied over at least a portion of the exterior surface that is adapted to improve the wear resistance of the piston pin. The wear resistant layer is intended to improve the tribological properties of the piston pin in a manner that also improves the ability of the pin to make sliding contact with the bores. For example, the wear resistant layer may prevent or resist wear between the parts, scuffing between the parts, galling between the parts, and seizure of the parts. In particular, the wear resistant layer can include materials and/or compounds that reduce the surface roughness and/or increase the hardness of the exterior surface of the pin. Further, the wear resistant layer can be applied to the piston pin by a mechanical process such as burnishing or honing which results in further improvement to the wear resistance, scuff resistance, and tribological properties of the pin.

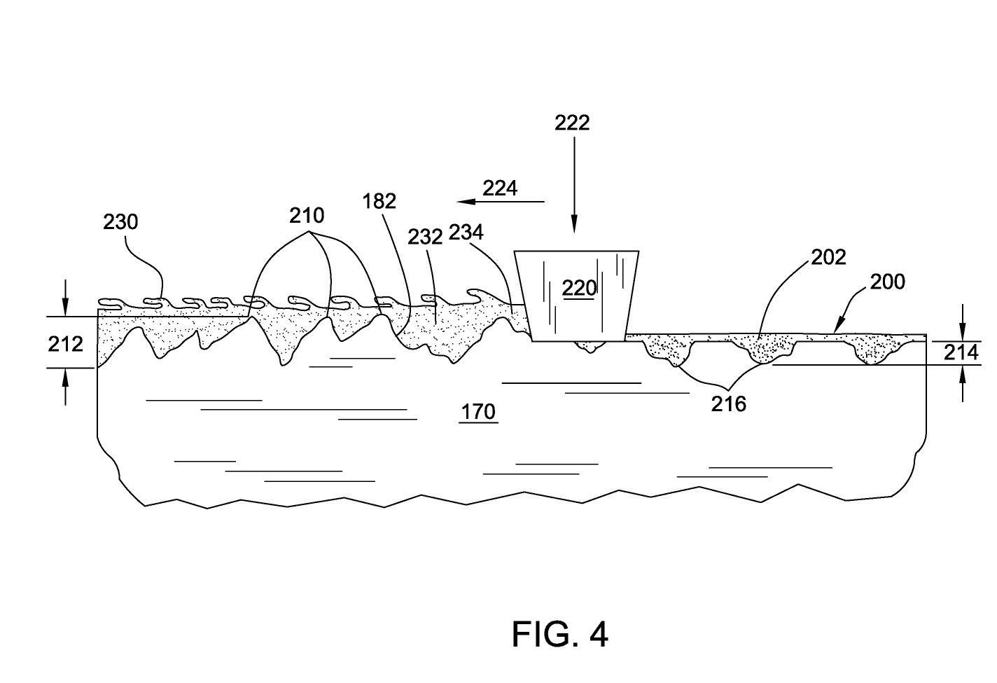

For example, referring to FIG. 4, there is illustrated on a microscopic scale a manufacturing process for applying the wear resistant layer 200 to the exterior surface 182 of the piston pin 170. The wear resistant layer 200 can include particles or grains of a wear resistant material 202 that are densely packed and that has a significant hardness and may be characterized by advantageous lubrication or frictionless properties. The particles or grains of the material 202 may bind to the exterior surface 182 of the piston pin 170 as a film or the like. The wear resistant material 202 may be or may include tungsten disulfide (WS₂) or molybdeum disulfide (MoS₂). Tungsten disulfide and molybdenum disulfide are known as solid lubricants that have low friction properties useful in applications requiring sliding contact between different parts. The wear resistant layer 200 can have any suitable thickness and in an embodiment may be on the order of 3 microns (3 μm) or less, or in a further embodiment may be 1 micron (1 μm) or less. Furthermore, the application for forming the wear resistant material 202 can further improve the exterior surface 182 of the piston 140 for sliding contact.

The exterior surface 182, prior to application of the wear resistant layer, may have an initial surface roughness characterized by a plurality of asperities 210, or microscopic peaks and valleys formed on the exterior surface, having an initial or first height 212. It should be appreciated that the asperities 210 are responsible for the roughness of the exterior surface 182 and, when the piston pin 170 is placed in sliding contact with another part, generate friction that is responsible in part for wear between parts. To reduce the first height 212 of the asperities 210, a mechanical manufacturing process such as burnishing, honing, or polishing may be conducted on the piston pin 170. In such a process, a hardened tool 220 is placed adjacent the exterior surface 182 and pressure is applied against the tool into the surface in a perpendicular, first direction 222 while the tool is moved over the surface in a parallel second direction 224. In various embodiments, the tool 220 may be made of sufficiently hard material such as tungsten carbide or diamond. As the tool moves in the second direction 224, the peaks of the asperities 210 may be plastically deformed, broken down, or cut away so that the asperities have a second height 214 which may be less than the first height 212, thereby reducing the friction generating potential of the exterior surface 182. In burnishing processes in particular, the material is displaced rather than removed to provide a flatter surface.

After the asperities 210 have been reduced to the lesser second height 214, there may remain a plurality of microscopic dimples 216 or the like in which the wear resistant material 202 of the wear resistant layer 200 is retained. To apply the wear resistant material 202, a slurry or process fluid 230 can be applied over the exterior surface 182 during the manufacturing process prior to the tool 220 being moved with respect to the surface. The process fluid 230 may assist the burnishing process by, for example, removing heat or function as a cutting fluid or an abrasive fluid during the manufacturing process. The process fluid 230 may contain sulfur 232 and may include additional chemicals including possibly tungsten and/or molybdenum 234. In addition, the tool 220 itself may contain tungsten or molybdenum. It is believed that as the tool 220 is moved over the exterior surface, the pressure and temperatures being applied in the first direction 222 cause a chemical reaction in which the low friction, wear resistant material 202 in the form of tungsten disulfide or molybdenum disulfide is formed as a solid layer deposited on the exterior surface 182 and in the dimples 216. Some of the sulfur 232 may also react with iron in the material of the piston pin 170 to form iron disulfide (FeS₂) which may help bind the wear resistant material 202 to the exterior surface 182. The practice of using the manufacturing process to cause a chemical reaction among the materials that produces the low friction, solid, wear resistant layer from a process fluid is sometimes referred to as tribochemical deposition, triboconditioning, or mechanochemical finishing.

Referring back to FIG. 2, the wear resistant layer 200 may be applied over the entire length of the piston pin 170 or only over a portion of the pin. For example, in the illustrated embodiment, the wear resistant layer 200 may be applied only at the first pin end 172 and the second pin end 174 while the midsection 176 lacks the layer. Accordingly, the exterior surface 182 at the first and second pin end 172, 174 may be substantially tungsten disulfide or molybdenum disulfide while at the surface of the midsection is exposed iron or steel. The wear resistant layer may be deposited on the piston pin 170 in a manner such that the pin can retain its overall cylindrical shape. Shaped and configured burnishing tools and honing tools can be utilized to apply the layer on only the designated portions of the piston pin.

### INDUSTRIAL APPLICABILITY

Referring to FIG. 3, the disclosure provides a piston-connecting rod assembly for use in an internal combustion engine 100 where the piston pin 170 that mates the piston 140 and connecting rod 160 together is configured with a wear resistant layer 200. The wear resistant layer 200 is characterized by lubrication properties and/or hardness values that help facilitate pivotal motion and sliding contact between the piston 140 and the connecting rod 160. In particular, the wear resistant layer 200 can include a wear resistant material such as tungsten disulfide or molybdenum disulfide that is bound to the exterior surface of the iron or steel piston pin 170. In addition, the wear resistant layer 200 can be applied by a mechanical manufacturing process that reduces the surface roughness of the exterior surface 182 to further reduce friction and prevent wear.

The wear resistant layer 200 may be applied across the length of the piston pin 170 or may be applied at select locations that optimize functionality of the layer. For example, in the embodiment illustrated in FIG. 3, when the piston pin 170 is installed to mate the piston 140 and the connecting rod 160 together, the first pin end 172 and the second pin end 174 of the pin are respectively disposed in a first pin bore 192 and in a second pin bore 194 of the piston. The wear resistant layer 200 may be applied only at the first pin end 172 and the second pin end 174. The wear resistant layer 200 therefore avoids or prevents directed contact between the iron or steel material of the piston 140 and the iron or steel material of the piston pin 170, which may be susceptible to increased friction and wear, even though the piston and the piston pin are in direct sliding contact. Bushings can be eliminated from the first and second pin bores 192, 194 of the piston 140 and the piston pin 170 and pin bores are journaled in direct sliding contact.

The piston pin 170 is also accommodated through the cross-bore 196 disposed through the piston end 162 of the connecting rod 160, where the midsection 176 of the piston pin may be in contact with the copper or bronze bushing 199 if included. Because of the possible presence of the bushing 199, the midsection 176 of the piston pin 170 does not require the wear resistant layer 200 to avoid iron-to-iron or steel-to-steel contact and the iron or steel based pin can be in direct sliding contact with the bushing. Further, by not depositing the wear resistant layer 200 on the midsection 176, any possible adverse reaction between the sulfides or other elements in the wear resistant material and the bronze or copper material of the bushing 19 can be avoided.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A piston-connecting rod assembly for an internal combustion engine comprising:
a piston including a crown and a skirt depending from the crown, the skirt including a first pin bore and a second pin bore aligned with the first pin bore;
a connecting rod including a piston end having a cross-bore and a crank end adapted to connect to a crankshaft, the piston end and the crank end interconnected by a beam; and
a piston pin received through the first pin bore and the second pin bore and the cross-bore, the piston pin having a wear resistant layer including at least one of tungsten-disulfide and molybdenum disulfide applied on at least a portion of an exterior surface of the piston pin.

2. The piston-connecting rod assembly of claim 1, wherein the piston pin includes a first pin end, a midsection, and a second pin end, the wear resistant layer applied only on the first pin end and the second pin end.

3. The piston-connecting rod assembly of claim 2, wherein the piston pin is an iron based material.

4. The piston-connecting rod assembly of claim 3, further including a bushing disposed in the cross-bore of the connecting rod.

5. The piston-connecting rod assembly of claim 4, wherein the bushing is selected from a material consisting of copper and bronze.

6. The piston-connecting rod assembly of claim 5, wherein the piston is an iron based material.

7. The piston-connecting rod assembly of claim 6, wherein the first pin end and the second pin end of the piston pin are in direct sliding contact with first pin bore and the second pin bore of the piston.

8. The piston-connecting rod assembly of claim 7, wherein the piston pin floats freely with respect to the piston and the connecting rod.

9. The piston-connecting rod assembly of claim 1, wherein the wear resistant layer has a thickness of about 3 microns or less.

10. The piston-connecting rod assembly of claim 1, wherein the wear resistant layer is formed by a process selected from the group consisting of a tribochemical deposition process, a triboconditioning process, or mechanochemical finishing.

11. The piston-connecting rod assembly of claim 1, wherein the connecting rod includes a lubrication channel disposed from the crank end to the piston end.

12. A method of constructing a piston-connecting rod assembly having a piston and a connecting rod pivotally connected together, the method comprising:
forming a piston pin having a first pin end, a second pin end, and a midsection between the first pin end and the second pin end;
applying a wear resistant layer to at least a portion of the piston pin, the wear resistant layer including at least one of tungsten disulfide and molybdenum disulfide;
aligning a cross-bore disposed in the connecting rod with a first pin bore and a second pin bore disposed in the piston; and
inserting the piston pin into the first pin bore, the cross-bore, and the second pin bore to pivotally connect the piston and the connecting rod.

13. The method of claim 12, further wherein the wear resistant layer is applied to only the first pin end and the second pin end of the piston pin.

14. The method of claim 13, wherein the step of applying the wear resistant layer is accomplished by a manufacturing process selected from a group comprising burnishing, honing, and polishing the piston pin.

15. The method of claim 14, wherein the manufacturing process is conducted with a process fluid comprising sulfur.

16. The method of claim 12, wherein the piston, the connecting rod, and the piston pin are comprised of an iron based material.

17. The method of claim 12, further comprising inserting a bushing into the cross-bore of the piston pin.

18. The method of claim 17, wherein the bushing comprises a material selected from copper and bronze.

19. A piston pin for pivotally connecting a piston and a connecting rod together, the piston pin comprising:
a body generally cylindrical in shape and made of an iron based material, the body having a first pin end, a second pin end, and a midsection disposed between the first pin end and the second pin end;
a wear resistant layer including at least one of tungsten disulfide and molybdenum disulfide, the wear resistant layer applied to at least the first pin end and the second pin end.

20. The piston pin of claim 19, wherein the wear resistant layer is applied by a process selected from the group consisting of a tribochemical deposition process, a triboconditioning process, or mechanochemical finishing.
